(19) United States
(12) Patent Application Publication
(10) Pub. No.: US 2021/0155262 A1
(43) Pub. Date: May 27, 2021

(54) ELECTRONIC APPARATUS AND OPERATION METHOD THEREOF

(71) Applicant: LG Electronics Inc., Seoul (KR)

(72) Inventors: Hyunkyu KIM, Seoul (KR); Junyoung JUNG, Seoul (KR); Sangkyeong JEONG, Seoul (KR); Kibong SONG, Seoul (KR); Chulhee LEE, Seoul (KR)

(21) Appl. No.: 16/730,445

(22) Filed: Dec. 30, 2019

(30) Foreign Application Priority Data
Nov. 27, 2019 (KR) 10-2019-0154575

(51) Int. Cl. B60W 60/00; G05B 13/02

(52) U.S. Cl. CPC B60W 60/0013; G06N 3/04; G05B 13/027

(57) ABSTRACT

Provided is a method of recognizing a state of an infant in a vehicle based on sensing information associated with the infant and determining a driving scheme of the vehicle for the infant based on the recognized state of the infant, and an electronic apparatus therefor. In the present disclosure, at least one of an electronic apparatus, a vehicle, a vehicle terminal, and an autonomous vehicle may be connected or converged with an artificial intelligence (AI) module, an unmanned aerial vehicle (UAV), a robot, an augmented reality (AR) device, a virtual reality (VR) device, a device associated with a 5G service, and the like.

### CROSS-REFERENCE TO RELATED APPLICATION

This application claims the benefit of Korean Patent Application No. 10-2019-0154575, filed on Nov. 27, 2019, the disclosure of which is incorporated herein in its entirety by reference.

### BACKGROUND

### 1. Field

This disclosure relates to a method of determining a driving scheme of a vehicle based on a state of an infant, and an electronic apparatus therefor.

### 2. Description of the Related Art

An infant in a vehicle may react sensitively to a driving environment of the vehicle. Accordingly, there is a desire for a method to effectively take care of the infant during driving of the vehicle.

An autonomous vehicle refers to a vehicle equipped with an autonomous driving device that recognizes an environment around the vehicle and a state of the vehicle to control driving of the vehicle based on the environment and the state. With progress in research on autonomous vehicles, studies on various services that may increase a user's convenience using the autonomous vehicle are also being conducted.

### SUMMARY

An aspect provides an electronic apparatus and an operation method thereof. Technical goals to be achieved through the example embodiments are not limited to the technical goals as described above, and other technical tasks can be inferred from the following example embodiments.

According to an aspect, there is provided an operation method of an electronic apparatus, the method including recognizing a state of an infant in a vehicle based on sensing information associated with the infant, determining a driving scheme of the vehicle for the infant based on the recognized state of the infant, and controlling the vehicle based on the determined driving scheme.

According to another aspect, there is also provided an electronic apparatus including
an interface configured to acquire sensing information associated with an infant in a vehicle, and a controller configured to recognize a state of the infant based on the acquired sensing information, determine a driving scheme of the vehicle for the infant based on the recognized state of the infant, and control the vehicle based on the determined driving scheme.

According to another aspect, there is also provided a non-volatile computer-readable recording medium including a computer program for performing the above-described method.

Specific details of example embodiments are included in the detailed description and drawings.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an artificial intelligence (AI) device according to an example embodiment;

FIG. 2 illustrates an AI server according to an example embodiment;

FIG. 3 illustrates an AI system according to an example embodiment;

FIG. 4 illustrates an operation of an electronic apparatus according to an example embodiment;

FIG. 5 is a flowchart illustrating an operation of an electronic apparatus according to an example embodiment;

FIG. 6 illustrates an electronic apparatus recognizing a state of an infant according to an example embodiment;

FIG. 7 illustrates an electronic apparatus generating an AI model for predicting a state of an infant according to an example embodiment;

FIG. 8 illustrates an electronic apparatus determining a driving scheme a vehicle for an infant according to an example embodiment;

FIG. 9 illustrates an electronic apparatus controlling an operation scheme of an in-vehicle device for an infant according to an example embodiment;

FIG. 10 illustrates an electronic apparatus controlling an operation scheme of an in-vehicle device for an infant according to another example embodiment;

FIG. 11 illustrates an electronic apparatus determining a driving scheme of a vehicle for an infant according to another example embodiment;

FIG. 12 illustrates an electronic apparatus determining a driving scheme of a vehicle for an infant according to another example embodiment; and

FIG. 13 is a block diagram illustrating an electronic apparatus.

### DETAILED DESCRIPTION

The terms used in the embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

In addition, in this specification, “artificial intelligence (AI)” refers to the field of studying artificial intelligence or a methodology capable of making the artificial intelligence, and “machine learning” refers to the field of studying methodologies that define and solve various problems handled in the field of artificial intelligence. The machine learning is also defined as an algorithm that enhances performance for a certain operation through a steady experience with respect to the operation.

An “artificial neural network (ANN)” may refer to a general model for use in the machine learning, which is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output the value of an activation function concerning signals input through the synapse, weights, and deflection thereof.

The model parameters refer to parameters determined by learning, and include weights for synaptic connection and deflection of neurons, for example. Then, hyper-parameters refer to parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function may be used as an index for determining an optimal model parameter in a learning process of the artificial neural network.

The machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by the artificial neural network when learning data is input to the artificial neural network. The unsupervised learning may refer to a learning method for the artificial neural network in the state in which no label for learning data is given. The reinforcement learning may refer to a learning method in which an agent defined in a certain environment learns to select a behavior or a behavior sequence that maximizes cumulative compensation in each state.

The machine learning realized by a deep neural network (DNN) including multiple hidden layers among artificial neural networks is also called deep learning, and the deep learning is a part of the machine learning. In the following description, the machine learning is used as a meaning including the deep learning.

In addition, in this specification, a vehicle may be an autonomous vehicle. “Autonomous driving” refers to a self-driving technology, and an “autonomous vehicle” refers to a vehicle that performs driving without a user's operation or with a user's minimum operation. In addition, the autonomous vehicle may refer to a robot having an autonomous driving function.

For example, autonomous driving may include all of a technology of maintaining the lane in which a vehicle is driving, a technology of automatically adjusting a vehicle speed such as adaptive cruise control, a technology of causing a vehicle to automatically drive in a given route, and a technology of automatically setting a route, along which a vehicle drives, when a destination is set.

Here, a vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described with reference to the drawings.

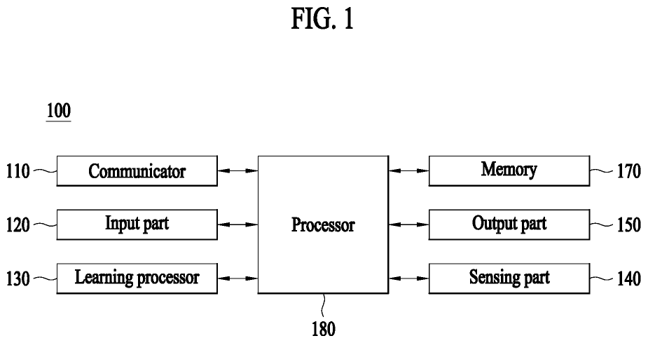

FIG. 1 illustrates an AI device according to an example embodiment.

The AI device 100 may be realized into, for example, a stationary appliance or a movable appliance, such as a TV, a projector, a cellular phone, a smartphone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, a vehicle, or an X reality (XR) device.

Referring to FIG. 1, the AI device 100 may include a communicator 110, an input part 120, a learning processor 130, a sensing part 140, an output part 150, a memory 170, and a processor 180. However, not all components shown in FIG. 1 are essential components of the AI device 100. The AI device may be implemented by more components than those illustrated in FIG. 1, or the AI device may be implemented by fewer components than those illustrated in FIG. 1.

The communicator 110 may transmit and receive data to and from external devices, such as other AI devices 100a to 100e and an AI server 200, using wired/wireless communication technologies. For example, the communicator 110 may transmit and receive sensor information, user input, learning models, and control signals, for example, to and from external devices.

At this time, the communication technology used by the communicator 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

The input part 120 may acquire various types of data.

At this time, the input part 120 may include a camera for the input of an image signal, a microphone for receiving an audio signal, and a user input part for receiving information input by a user, for example. Here, the camera or the microphone may be handled as a sensor, and a signal acquired from the camera or the microphone may be referred to as sensing data or sensor information.

The input part 120 may acquire, for example, input data to be used when acquiring an output using learning data for model learning and a learning model. The input part 120 may acquire unprocessed input data, and in this case, the processor 180 or the learning processor 130 may extract an input feature as pre-processing for the input data.

The learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, the learning processor 130 may perform AI processing along with a learning processor 240 of the AI server 200.

At this time, the learning processor 130 may include a memory integrated or embodied in the AI device 100. Alternatively, the learning processor 130 may be realized using the memory 170, an external memory directly coupled to the AI device 100, or a memory held in an external device.

The sensing part 140 may acquire at least one of internal information of the AI device 100, environmental information around the AI device 100, and user information using various sensors.

At this time, the sensors included in the sensing part 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, a radar, and a temperature sensor, for example.

The output part 150 may generate, for example, a visual output, an auditory output, or a tactile output.

At this time, the output part 150 may include, for example, a display that outputs visual information, a speaker that outputs auditory information, and a haptic module that outputs tactile information.

The memory 170 may store data which assists various functions of the AI device 100. For example, the memory 170 may store input data acquired by the input part 120, learning data, learning models, and learning history, for example. The memory 170 may include a storage medium of at least one type among a flash memory, a hard disk, a multimedia card micro type memory, a card type memory (e.g., SD or XD memory), a random access memory (RAM) a static random access memory (SRAM), a read only memory (ROM), an electrically erasable programmable read-only memory (EEPROM), a programmable read-only memory (PROM), a magnetic memory, a magnetic disc, and an optical disc.

The processor 180 may determine at least one executable operation of the AI device 100 based on information determined or generated using a data analysis algorithm or a machine learning algorithm. Then, the processor 180 may control constituent elements of the AI device 100 to perform the determined operation.

To this end, the processor 180 may request, search, receive, or utilize data of the learning processor 130 or the memory 170, and may control the constituent elements of the AI device 100 so as to execute a predictable operation or an operation that is deemed desirable among the at least one executable operation.

At this time, when connection of an external device is required to perform the determined operation, the processor 180 may generate a control signal for controlling the external device and may transmit the generated control signal to the external device.

The processor 180 may acquire intention information with respect to user input and may determine a user request based on the acquired intention information.

At this time, the processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by the learning processor 130, may have learned by a learning processor 240 of the AI server 200, or may have learned by distributed processing of these processors.

The processor 180 may collect history information including, for example, the content of an operation of the AI device 100 or feedback of the user with respect to an operation, and may store the collected information in the memory 170 or the learning processor 130, or may transmit the collected information to an external device such as the AI server 200. The collected history information may be used to update a learning model.

The processor 180 may control at least some of the constituent elements of the AI device 100 in order to drive an application program stored in the memory 170. Moreover, the processor 180 may combine and operate two or more of the constituent elements of the AI device 100 for the driving of the application program.

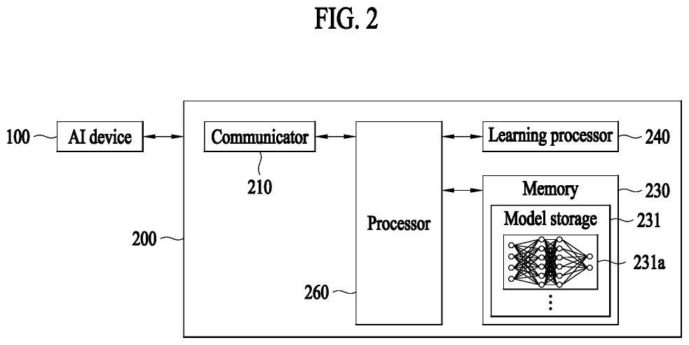

FIG. 2 illustrates an AI server according to an example embodiment.

Referring to FIG. 2, an AI server 200 may refer to a device that causes an artificial neural network to learn using a machine learning algorithm or uses the learned artificial neural network. Here, the AI server 200 may be constituted of multiple servers to perform distributed processing, and may be defined as a 5G network. At this time, the AI server 200 may be included as a constituent element of the AI device 100 so as to perform at least a part of AI processing together with the AI device.

The AI server 200 may include a communicator 210, a memory 230, a learning processor 240, and a processor 260.

The communicator 210 may transmit and receive data to and from an external device such as the AI device 100.

The memory 230 may include a model storage 231. The model storage 231 may store a model (or an artificial neural network 231a) which is learning or has learned via the learning processor 240.

The learning processor 240 may cause the artificial neural network 231a to learn learning data. A learning model may be used in the state of being mounted in the AI server 200 of the artificial neural network, or may be used in the state of being mounted in an external device such as the AI device 100.

The learning model may be realized in hardware, software, or a combination of hardware and software. In the case in which a part or the entirety of the learning model is realized in software, one or more instructions constituting the learning model may be stored in the memory 230.

The processor 260 may deduce a result value for newly input data using the learning model, and may generate a response or a control instruction based on the deduced result value.

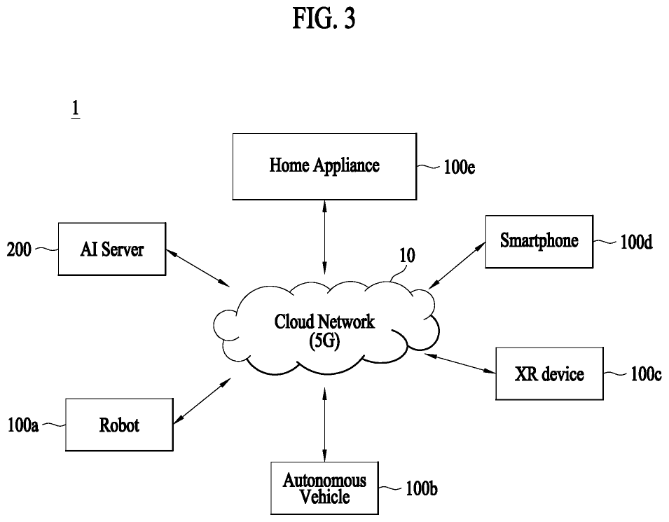

FIG. 3 illustrates an AI system according to an example embodiment.

Referring to FIG. 3, in the AI system 1, at least one of the AI server 200, a robot 100a, an autonomous vehicle 100b, an XR device 100c, a smartphone 100d, and a home appliance 100e is connected to a cloud network 10. Here, the robot 100a, the autonomous vehicle 100b, the XR device 100c, the smartphone 100d, and the home appliance 100e, to which AI technologies are applied, may be referred to as AI devices 100a to 100e.

The cloud network 10 may constitute a part of a cloud computing infrastructure, or may refer to a network present in the cloud computing infrastructure. Here, the cloud network 10 may be configured using a 3G network, a 4G or long term evolution (LTE) network, or a 5G network, for example.

That is, respective devices 100a to 100e and 200 constituting the AI system 1 may be connected to each other via the cloud network 10. In particular, respective devices 100a to 100e and 200 may communicate with each other via a base station, or may perform direct communication without the base station.

The AI server 200 may include a server which performs AI processing and a server which performs an operation with respect to big data.

The AI server 200 may be connected to at least one of the robot 100a, the autonomous vehicle 100b, the XR device 100c, the smartphone 100d, and the home appliance 100e, which are AI devices constituting the AI system 1, via cloud network 10, and may assist at least a part of AI processing of connected the AI devices 100a to 100e.

At this time, instead of the AI devices 100a to 100e, the AI server 200 may cause an artificial neural network to learn according to a machine learning algorithm, and may directly store a learning model or may transmit the learning model to the AI devices 100a to 100e.

At this time, the AI server 200 may receive input data from the AI devices 100a to 100e, may deduce a result value for the received input data using the learning model, and may generate a response or a control instruction based on the deduced result value to transmit the response or the control instruction to the AI devices 100a to 100e.

Alternatively, the AI devices 100a to 100e may directly deduce a result value with respect to input data using the learning model, and may generate a response or a control instruction based on the deduced result value.

Hereinafter, various example embodiments of the AI devices 100a to 100e, to which the above-described technology is applied, will be described. Here, the AI devices 100a to 100e illustrated in FIG. 3 may be specific example embodiments of the AI device 100 illustrated in FIG. 1.

The autonomous vehicle 100b may be realized into a mobile robot, a vehicle, or an unmanned air vehicle, for example, through the application of AI technologies.

The autonomous vehicle 100b may include an autonomous driving control module for controlling an autonomous driving function, and the autonomous driving control module may mean a software module or a chip realized in hardware. The autonomous driving control module may be a constituent element included in the autonomous vehicle 1200b, but may be a separate hardware element outside the autonomous vehicle 1200b so as to be connected thereto.

The autonomous vehicle 100b may acquire information on the state of the autonomous vehicle 1200b using sensor information acquired from various types of sensors, may detect or recognize the surrounding environment and an object, may generate map data, may determine a movement route and a driving plan, or may determine an operation.

Here, the autonomous vehicle 100b may use sensor information acquired from at least one sensor among a lidar, a radar, and a camera in the same manner as the robot 1200a in order to determine a movement route and a driving plan.

In particular, the autonomous vehicle 100b may recognize the environment or an object with respect to an area outside the field of vision or an area located at a predetermined distance or more by receiving sensor information from external devices, or may directly receive recognized information from external devices.

The autonomous vehicle 100b may perform the above-described operations using a learning model configured with at least one artificial neural network. For example, the autonomous vehicle 100b may recognize the surrounding environment and the object using the learning model, and may determine a driving line using the recognized surrounding environment information or object information. Here, the learning model may be directly learned in the autonomous vehicle 100b, or may be learned in an external device such as the AI server 200.

At this time, the autonomous vehicle 100b may generate a result using the learning model to perform an operation, but may transmit sensor information to an external device such as the AI server 200 and receive a result generated by the external device to perform an operation.

The autonomous vehicle 100b may determine a movement route and a driving plan using at least one of map data, object information detected from sensor information, and object information acquired from an external device, and a drive part may be controlled to drive the autonomous vehicle 100b according to the determined movement route and driving plan.

The map data may include object identification information for various objects arranged in a space (e.g., a road) along which the autonomous vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, the autonomous vehicle 100b may perform an operation or may drive by controlling the drive part based on user control or interaction. At this time, the autonomous vehicle 100b may acquire interactional intention information depending on a user operation or voice expression, and may determine a response based on the acquired intention information to perform an operation.

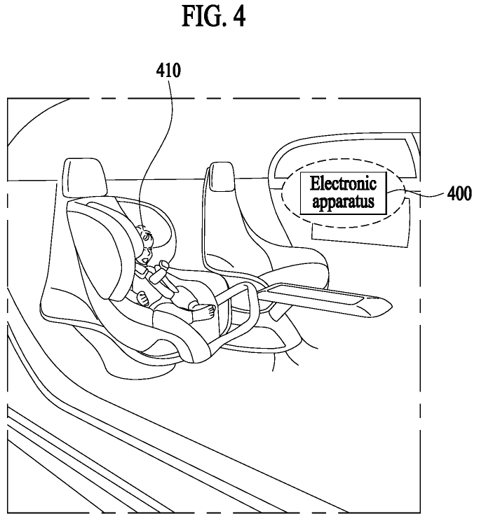

FIG. 4 illustrates an operation of an electronic apparatus according to an example embodiment.

In one example embodiment, an electronic apparatus 400 may be included in a vehicle and may be, for example, an in-vehicle terminal included in an autonomous vehicle. In another example embodiment, the electronic apparatus 400 may not be included in a vehicle and may be included in, for example, a server.

The electronic apparatus 400 may recognize a state of an infant 410 in a vehicle. In one example embodiment, the electronic apparatus 400 may recognize a state of the infant 410 based on sensing information associated with the infant 410. For example, the electronic apparatus 400 may recognize a hungry state, a sleeping state, or an eating state of the infant 410 based on sensing information associated with at least one of an appearance, a sound, and a gesture of the infant 410. In another example embodiment, the electronic apparatus 400 may recognize a state of the infant 410 based on information associated with an environment around the infant 410. For example, the electronic apparatus 400 may recognize a sleeping state of the infant 410 based on current time information.

The electronic apparatus 400 may determine a driving scheme of the vehicle for the infant 410 based on the state of the infant 410. Specifically, the electronic apparatus 400 may determine a driving speed or a predicted driving route of the vehicle based on the state of the infant 410. For example, when the state of the infant 410 is the sleeping state, the electronic apparatus 400 may determine the predicted driving route to be a straight road-oriented driving route. As such, the electronic apparatus 400 may control the vehicle based on the determined driving scheme, thereby implementing a driving environment for the infant 410.

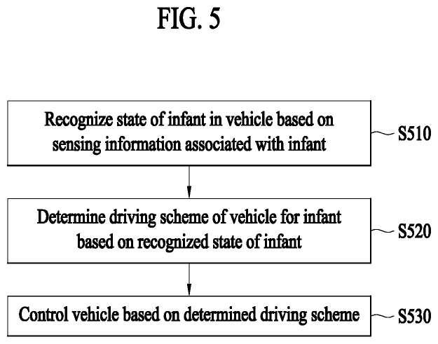

FIG. 5 is a flowchart illustrating an operation of an electronic apparatus according to an example embodiment.

In operation S510, the electronic apparatus 400 may recognize a state of an infant in a vehicle based on sensing information associated with the infant. Specifically, the electronic apparatus 400 may acquire sensing information associated with the infant and recognize a state of the infant based on the acquired sensing information. The term “infant” may refer to a small and/or little child. In one example, the infant may be a baby who is not yet able to speak. In another example, the infant may be a toddler able to stand and walk with help or alone. In another example, the infant may be a preschooler 1 to 6 years old after birth.

In one example embodiment, at least one in-vehicle sensor may sense the infant and transmit sensing information associated with the infant to the electronic apparatus 400. The sensing information associated with the infant may include information associated with at least one of an appearance, a sound, and a gesture of the infant. The at least one in-vehicle sensor may include a camera or a microphone.

In another example embodiment, the electronic apparatus 400 may include at least one sensor and acquire sensing information associated with the infant using the at least one sensor. In another example embodiment, the electronic apparatus 400 may acquire, from a memory, sensing information associated with the infant stored in the memory.

The electronic apparatus 400 may recognize a state of the infant based on the sensing information associated with the infant using a model for predicting a state of the infant.

In one example embodiment, the model for predicting a state of the infant may be a model representing a correlation between first information associated with at least one of an appearance, a sound, and a gesture and second information associated with a state of the infant, the second information corresponding to the first information. The model for predicting a state of the infant may be an AI model. For example, the model for predicting a state of the infant may be a deep-learning model trained based on first information associated with at least one of an appearance, a sound, and a gesture and second information associated with a state of the infant. In this example, the second information may be target information of the first information. Thus, the electronic apparatus 400 may recognize a state of the infant based on information inferred as a result of inputting the sensing information associated with the infant to the AI model for predicting a state of the infant. For example, the electronic apparatus 400 may recognize a hungry state of the infant based on information inferred as a result of inputting sensing information associated with a sound of the infant to the AI model.

In another example embodiment, the model for predicting a state of the infant may be a model modeled based on information associated with a state of the infant on an hourly basis. The model for predicting a state of the infant may include information associated with a life pattern of the infant on an hourly basis. Thus, the electronic apparatus 400 may recognize a state of the infant based on a current time through the model for predicting a state of the infant. For example, when a current time is 1:00 am, the electronic apparatus 400 may recognize a sleeping state of the infant through the model for predicting a state of the infant.

In operation S520, the electronic apparatus 400 may determine a driving scheme of the vehicle for the infant based on the state of the infant recognized in operation S510. Specifically, the electronic apparatus 400 may determine a driving speed or a predicted driving route the vehicle suitable for the recognized state of the infant. For example, when the recognized state of the infant is an eating state, the electronic apparatus 400 may determine a predicted driving route including a minimum curve section.

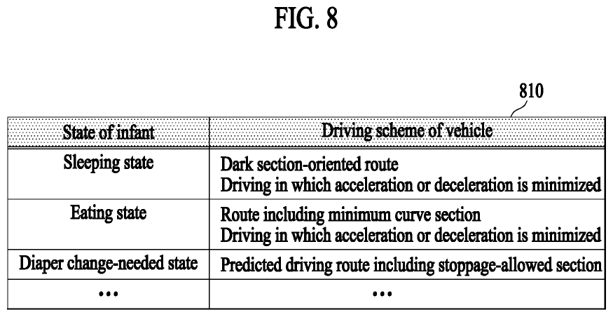

The electronic apparatus 400 may acquire information associated with a driving scheme suitable for taking care of the infant for each state of the infant and determine a driving scheme of the vehicle based on the acquired information. Related description will be made in detail with reference to FIG. 8.

The electronic apparatus 400 may determine an operation scheme of at least one device in the vehicle based on the state of the infant recognized in operation S510. In one example embodiment, the electronic apparatus 400 may determine an operation scheme of a car seat mounted in the vehicle based on a state of the infant. For example, when the infant is sleeping, the electronic apparatus 400 may backwardly tilt the car seat in which the infant is seated by adjusting an inclination angle of the car seat for a comfortable sleep of the infant. In another example embodiment, the electronic apparatus 400 may determine an operation scheme of a toy wired or wirelessly connected to the vehicle based on a state of the infant. For example, when the infant is crying, the electronic apparatus 400 may control an operation of a baby mobile to take care of the infant. In another example embodiment, the electronic apparatus 400 may determine an operation scheme of a display device, an audio device, or a lighting device in the vehicle based on a state of the infant. For example, when the infant is sleeping, the electronic apparatus 400 may dim the lighting device for a comfortable sleep of the infant.

The electronic apparatus 400 may acquire a model representing a preference of the infant with respect to a driving environment of the vehicle and determine a driving scheme of the vehicle for the infant based on the acquired model. The model representing a preference of the infant with respect to a driving environment of the vehicle may be an AI model trained based on first information associated with a driving environment of the vehicle and second information associated with a state of the infant, the second information being target information of the first information. The electronic apparatus 400 may determine at least one of a driving speed and a driving route of the vehicle using the model representing a preference of the infant with respect to a driving environment of the vehicle. By using the model representing a preference of the infant with respect to a driving environment of the vehicle, the electronic apparatus 400 may determine a driving speed or a driving route preferred by the infant.

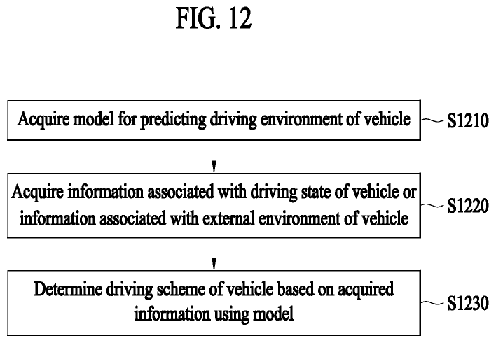

The electronic apparatus 400 may acquire a model for predicting a driving environment of the vehicle. The model for predicting a driving environment of the vehicle may be an AI model trained based on input information that is information associated with a driving state of the vehicle or an external environment of the vehicle, and target information that is information associated with an actual driving environment of the vehicle. By using the acquired model, the electronic apparatus 400 may recognize the actual driving environment of the vehicle based on information associated with the driving state of the vehicle or information associated with the external environment of the vehicle, and determine a driving scheme of the vehicle based on the recognized actual driving environment. Related description will be made in detail with reference to FIG. 12.

The electronic apparatus 400 may provide a guide for taking care of the infant in the vehicle based on the state of the infant recognized in operation S510. The electronic apparatus 400 may provide a guide for taking care of the infant based on a state of the infant through an output device. For example, when the infant is nervous, the electronic apparatus 400 may provide information associated with a toy preferred by the infant to a guardian of the infant.

In operation S530, the electronic apparatus 400 may control the vehicle based on the driving scheme determined in operation S520. Specifically, the electronic apparatus 400 may control the vehicle based on the driving speed or driving route determined in operation S520.

The electronic apparatus 400 may control an operation scheme of at least one device in the vehicle based on the operation scheme determined in operation 5520. For example, the electronic apparatus 400 may control an operation scheme of at least one of a car seat, a lighting device, a display device, an acoustic device, and a toy in the vehicle.

As such, the electronic apparatus 400 may recognize a state of the infant and determine a driving scheme of the vehicle based on the recognized state of the infant, thereby implementing driving for taking care of the infant. Also, the electronic apparatus 400 may determine an operation scheme of at least one device in the vehicle based on the recognized state of the infant, thereby implementing an effective child care during the driving of the vehicle.

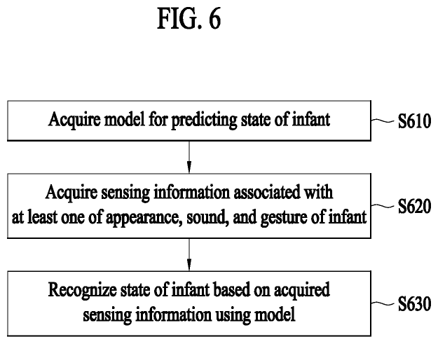

FIG. 6 illustrates an electronic apparatus recognizing a state of an infant according to an example embodiment.

In operation 5610, the electronic apparatus 400 may acquire a model for predicting a state of an infant. The model for predicting a state of the infant may be an AI model. For example, the model for predicting a state of the infant may be a deep-learning model trained based on first information associated with at least one of an appearance, a sound, and a gesture and second information associated with a state of the infant. The second information may be target information of the first information.

In one example embodiment, the electronic apparatus 400 may generate a model for predicting a state of the infant. The electronic apparatus 400 may acquire first information associated with at least one of an appearance, a sound, and a gesture of the infant as input information, and then acquire second information associated with a state of the infant as target information of the first information. For example, the electronic apparatus 400 may acquire information associated with an appearance or a gesture of the infant as input information using a home Internet of Thing (IoT)-based camera, acquire information associated with a sound of the infant as input information using a home IoT-based microphone, and acquire information associated with a state of the infant corresponding to the input information as target information. Thereafter, the electronic apparatus 400 may train an AI model based on the acquired input information and target information. Through this, the electronic apparatus 400 may generate a trained AI model.

In another example embodiment, the electronic apparatus 400 may receive a model for predicting a state of the infant from an external device. For example, the external device may generate the model for predicting a state of the infant at home and transmit information associated with the generated model to the electronic apparatus 400. In another example embodiment, the electronic apparatus 400 may acquire, from a memory, a model for predicting a state of the infant stored in the memory.

In operation 5620, the electronic apparatus 400 may acquire sensing information associated with at least one of an appearance, a sound, and a gesture of the infant. The electronic apparatus 400 may acquire the sensing information associated with at least one of an appearance, a sound, and a gesture of the infant from at least one sensor.

The electronic apparatus 400 may determine a validity of the acquired sensing information. Specifically, the electronic apparatus 400 may determine a validity of the sensing information acquired in operation S620 based on the model acquired in S610. When the sensing information acquired in operation S620 is a different type of information from information for training the model acquired in operation S610, the electronic apparatus 400 may determine that the acquired sensing information is invalid. For example, when the sensing information is sensing information associated with a reaction of the infant in a special circumstance, the electronic apparatus 400 may determine that the sensing information is invalid.

In operation S630, the electronic apparatus 400 may recognize a state of the infant using the model acquired in operation S610 based on the sensing information associated with at least one of an appearance, a sound, and a gesture of the infant acquired in operation S620. In one example embodiment, the electronic apparatus 400 may input the sensing information associated with at least one of an appearance, a sound, and a gesture of the infant to an AI model for predicting a state of the infant and recognize a state of the infant inferred as a result of the inputting. For example, the electronic apparatus 400 may input sensing information associated with facial expression of the infant to the AI model and recognize a nervous state of the infant inferred as a result of the inputting.

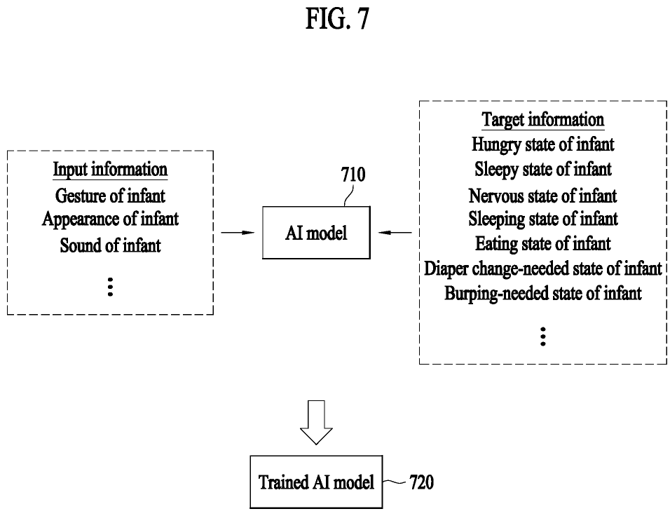

FIG. 7 illustrates an electronic apparatus generating an AI model for predicting a state of an infant according to an example embodiment.

The electronic apparatus 400 may acquire information associated with at least one of a gesture, an appearance, and a sound of an infant as input information, acquire information associated with a state of the infant corresponding to at least one of the gesture, the appearance, and the sound of the infant as target information, and train an AI model 710 based on the acquired input information and target information. For example, the electronic apparatus 400 may train the AI model 710 based on information associated with a gesture, an appearance, or a sound representing at least one of a hungry state, a sleepy state, an eating state, a diaper change-needed state, and a burping-needed state of the infant.

In one example, the electronic apparatus 400 may analyze an infant caring scheme based on a facial expression of the infant captured by a camera and a sound collected by a microphone, and train the AI model 710 based on an analysis result. For example, the electronic apparatus 400 may train the AI model 710 using a diaper change image matching a crying sound of the infant. In another example, the electronic apparatus 400 may define a gesture pattern by analyzing a gesture of the infant acquired through the camera and train the AI model 710 based on the gesture pattern and a state of the infant represented by the gesture pattern. In another example, the electronic apparatus 400 may acquire an image of the infant who recognizes devices around the infant through the camera and train the AI model 710 based on the acquired image. For example, the electronic apparatus 400 may train the AI model 710 based on an image of the infant enjoying listening to music through a headset.

As such, the electronic apparatus 400 may train the AI model 710. Through this, the electronic apparatus 400 may generate an AI model 720 trained to predict a state of the infant, a tendency of the infant, a life pattern of the infant, a device comforting the infant, and requirements of the infant.

FIG. 8 illustrates an electronic apparatus determining a driving scheme of a vehicle for an infant according to an example embodiment.

The electronic apparatus 400 may determine a driving scheme of a vehicle for an infant based on a state of the infant. In one example embodiment, the electronic apparatus 400 may determine a driving scheme of the vehicle based on information 810 on a driving scheme suitable for taking care of the infant for each state of the infant.

For example, when the infant is sleeping, the electronic apparatus 400 may determine a dark section-oriented route such as a tunnel or a path through a forest to be a predicted driving route of the vehicle for a comfort sleep of the infant and determine a driving speed such that an acceleration or deceleration of the vehicle is minimized. When the infant is eating, the electronic apparatus 400 may determine a route including a minimum curve section to be a predicted driving route for a stable meal of the infant and determine a driving speed such that an acceleration or deceleration of the vehicle is minimized. When a diaper change is needed, the electronic apparatus 400 may determine a route including a stoppage-allowed section to be a predicted driving route of the vehicle for a smooth diaper change of the infant.

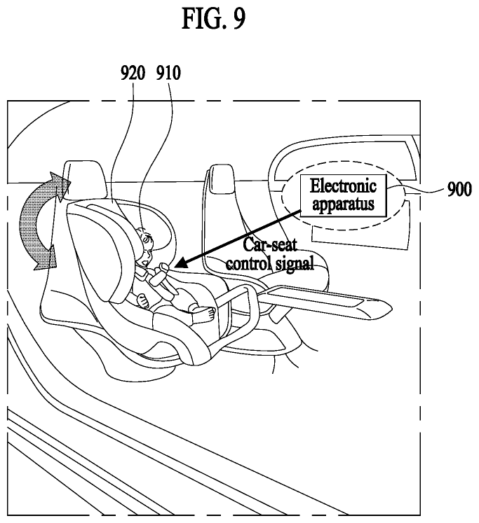

FIG. 9 illustrates an electronic apparatus controlling an operation scheme of an in-vehicle device for an infant according to an example embodiment.

An electronic apparatus 900 may determine an operation scheme of a car seat 920 in which an infant 920 is seated based on a state of the infant 910. In one example embodiment, the electronic apparatus 900 may determine an inclination angle, a height, or a position of the car seat 920 suitable for taking care of the infant 910 for each state of the infant 910. The electronic apparatus 900 may transmit a control signal to the car seat 920 based on the determined operation scheme and control an operation of the car seat 920. The electronic apparatus 900 may control the car seat 920 through, for example, controller area network (CAN) communication.

For example, when the infant 910 is sleeping or a diaper change is needed, the electronic apparatus 900 may tilt the car seat 920 backward by adjusting an inclination of the car seat 920 in which the infant 920 is seated by 90 degrees (°). When the infant 910 needs to burp, the electronic apparatus 900 may control the car seat 920 to operate in a vibration mode for burping the infant 910. When the infant 910 is eating, the electronic apparatus 900 may tilt the car seat 920 backward by adjusting the inclination of the car seat 920 by an angle of 30° to 45° for ease of the eating of the infant 910. When the infant 910 is nervous, the electronic apparatus 900 may control the inclination of the car seat 920 to be repetitively changed within a predetermined degree of angle to comfort the infant 910.

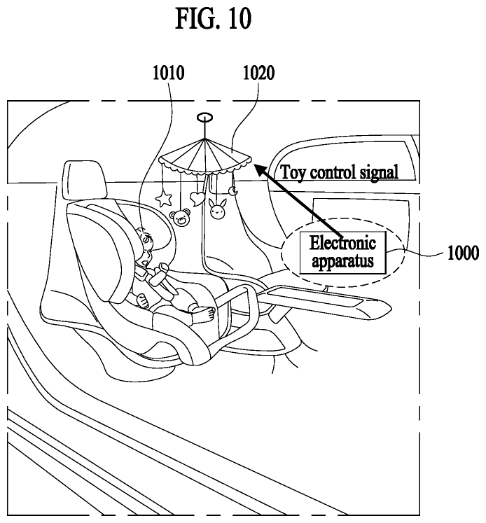

FIG. 10 illustrates an electronic apparatus controlling an operation scheme of an in-vehicle device for an infant according to another example embodiment.

An electronic apparatus 1000 may determine an operation scheme of a toy 1020 wired or wirelessly connected to the electronic apparatus 1000 based on a state of an infant 1010. Specifically, the electronic apparatus 1000 may determine an operation scheme of the toy 1020 suitable for taking care of the infant 1010 for each state of the infant 1010. The electronic apparatus 1000 may transmit a control signal to the toy 1020 based on the determined operation scheme and control an operation of the toy 1020. The electronic apparatus 1000 may control the toy 1020 through, for example, CAN communication.

For example, when the infant 1010 is crying or nervous, the electronic apparatus 1000 may provide the toy 1020 to a field of view of the infant 1010 to comfort the infant 1010. Also, the electronic apparatus 1000 may select the toy 1020 preferred by the infant 1010 from a plurality of toys in a vehicle based on information associated with a preference of the infant, and provide the selected toy 1020 to the infant 1010.

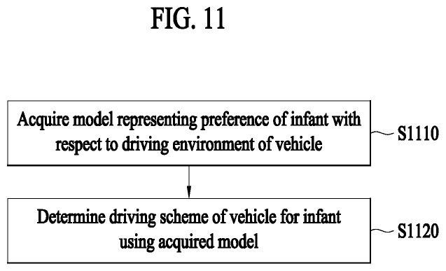

FIG. 11 illustrates an electronic apparatus determining a driving scheme of a vehicle for an infant according to another example embodiment.

In operation S1110, the electronic apparatus 400 may acquire a model representing a preference of an infant with respect to a driving environment of a vehicle. The model may be an AI model trained in advance. Specifically, the model representing the preference of the infant with respect to the driving environment of the vehicle may be a deep-learning model trained based on first information associated with a driving environment of the vehicle and second information associated with a state of the infant, the second information being target information of the first information.

In one example embodiment, the electronic apparatus 400 may generate a model representing a preference of an infant with respect to a driving environment of a vehicle. The electronic apparatus 400 may acquire first information associated with at least one of a driving route, a road condition around the vehicle, and a driving speed of the vehicle as input information, and then acquire second information associated with a state of the infant as target information of the first information. For example, the electronic apparatus 400 may acquire the first information from a sensor or a navigator in the vehicle and acquire the second information from a camera or a microphone in the vehicle. Thereafter, the electronic apparatus 400 may train an AI model based on the acquired input information and target information. Through this, the electronic apparatus 400 may generate a trained AI model.

For example, the electronic apparatus 400 may train an AI model based on information associated with the driving speed of the vehicle, which is the first information, and information associated with a reaction of the infant for each speed level of the vehicle, which is the second information. Through this, the electronic apparatus 400 may generate a model representing a preference of the infant with respect to the driving speed of the vehicle. Also, the electronic apparatus 400 may train an AI model based on information associated with the driving route of the vehicle, which is the first information, and information associated with a reaction of the infant for each driving route of the vehicle. Through this, the electronic apparatus 400 may generate a model representing a preference of the infant with respect to the driving route of the vehicle.

In another example embodiment, the electronic apparatus 400 may receive, from an external device, a model representing a preference of an infant with respect to a driving environment of a vehicle. In another example embodiment, the electronic apparatus 400 may acquire a model representing a preference of an infant with respect to a driving environment of a vehicle stored in a memory from the memory.

In operation S1120, the electronic apparatus 400 may determine a driving scheme of the vehicle for the infant based on the model acquired in operation S1110.

The electronic apparatus 400 may determine at least one of the driving speed and the driving route of the vehicle based on the model representing the preference of the infant with respect to the driving environment of the vehicle. For example, by using the model representing the preference of the infant with respect to the driving environment of the vehicle, the electronic apparatus 400 may recognize that the infant is in a nervous state during a fast driving at a speed of 100 kilometers per hour (km/h) of more. In this example, the electronic apparatus 400 may determine to maintain the driving speed at 100 km/h or less. Also, by using the model representing the preference of the infant with respect to the driving environment of the vehicle, the electronic apparatus 400 may recognize that the infant is in a pleasant state during driving on a downhill road. Thus, the electronic apparatus 400 may determine a route including a downhill road to be the driving route.

FIG. 12 illustrates an electronic apparatus determining a driving scheme of a vehicle for an infant according to another example embodiment.

In operation S1210, the electronic apparatus 400 may acquire a model for predicting a driving environment of a vehicle. For example, the model for predicting the driving environment of the vehicle may be a model for predicting a road condition of a traveling road of the vehicle. Also, the model for predicting the driving environment of the vehicle may be a model for predicting an unstable factor in a driving route of the vehicle. The unstable factor in the driving route may include, for example, a sudden curve section, an uphill section, a downhill section, and a congestion section. The model for predicting the driving environment of the vehicle may be a trained AI model.

In one example embodiment, the electronic apparatus 400 may generate a model for predicting a driving environment of a vehicle. The electronic apparatus 400 may acquire information associated with a driving state of the vehicle or information associated with an external environment of the vehicle as input information, and acquire information associated with an actual driving environment as target information of the input information. For example, the electronic apparatus 400 may acquire information associated with the external environment of the vehicle from a camera, a radar sensor, a lidar sensor, or an ultrasonic sensor in the vehicle as input information, and acquire information associated with an actual road condition of a traveling road of the vehicle as target information. Also, the electronic apparatus 400 may acquire, for example, shock absorber- or damper-based vehicle gradient information, gyro sensor information, steering wheel information, suspension information, vehicle speed information, vehicle revolutions per minute (RPM) information, and predicted driving route information as input information, and acquire information associated with an unstable factor in an actual driving route of the vehicle as target information. Thereafter, the electronic apparatus 400 may train an AI model based on the acquired input information and target information. Through this, the electronic apparatus 400 may generate a trained AI model.

In another example embodiment, the electronic apparatus 400 may receive, from an external device, a model for predicting a driving environment of a vehicle. In another example embodiment, the electronic apparatus 400 may acquire a model for predicting a driving environment of a vehicle stored in a memory from the memory.

In operation S1220, the electronic apparatus 400 may acquire information associated with a driving state of the vehicle or information associated with an external environment of the vehicle. Specifically, the electronic apparatus 400 may acquire sensing information associated with the external environment of the vehicle from a camera, a radar sensor, a lidar sensor, or an ultrasonic sensor in the vehicle, and acquire shock absorber- or damper-based vehicle gradient information, vehicle speed information, vehicle RPM information, predicted driving route information, or the like, from the vehicle.

In operation S1230, the electronic apparatus 400 may determine a driving scheme of the vehicle using the model acquired in operation S1210 based on the information acquired in operation S1220. For example, the electronic apparatus 400 may recognize an unstable factor in a predicted driving route of the vehicle using the model for predicting the driving environment of the vehicle and thus, may set a predicted driving route again to avoid the unstable factor. For example, the electronic apparatus 400 may determine a predicted driving route such that a sudden curve section, an uphill section, and a downhill section are not included in the predicted driving route.

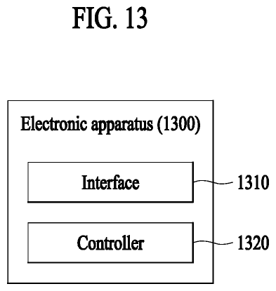

FIG. 13 is a block diagram illustrating an electronic apparatus.

An electronic apparatus 1300 may be included in a vehicle in one example embodiment and may be included in a server in another example embodiment.

The electronic apparatus 1300 may include an interface 1310 and a controller 1320. FIG. 13 illustrates only components of the electronic apparatus 1300 related to the present embodiment. However, it will be understood by those skilled in the art that other general-purpose components may be further included in addition to the components illustrated in FIG. 13.

The interface 1310 may acquire sensing information associated with an infant in a vehicle. Specifically, the interface 1310 may acquire sensing information associated with at least one of an appearance, a sound, and a gesture of the infant. In one example embodiment, the interface 1310 may acquire sensing information associated with the infant from at least one sensor of the vehicle. In another example embodiment, the interface 1310 may acquire sensing information associated with the infant from at least one sensor of the electronic apparatus 1300. In another example embodiment, the interface 1310 may acquire sensing information associated with the infant from a memory of the electronic apparatus 1300.

The controller 1320 may control an overall operation of the electronic apparatus 1300 and process data and a signal. The controller 1320 may include at least one hardware unit. In addition, the controller 1320 may operate through at least one software module generated by executing program codes stored in a memory.

The controller 1320 may recognize a state of the infant based on the sensing information acquired by the interface 1310 and determine a driving scheme of the vehicle for the infant based on the state of the infant. Specifically, the controller 1320 may determine at least one of a predicted driving route and a driving speed of the vehicle based on the state of the infant. Also, the controller 1320 may control the vehicle based on the determined driving scheme.

The controller 1320 may determine an operation scheme of at least one device in the vehicle based on the state of the infant and control the at least one device based on the determined operation scheme.

The interface 1310 may acquire a model for predicting a state of the infant and acquire sensing information associated with at least one of an appearance, a sound, and a gesture of the infant. The controller 1320 may recognize a state of the infant based on the acquired sensing information using the acquired model.

The interface 1310 may acquire a model representing a preference of the infant with respect to a driving environment of the vehicle and may determine a driving scheme of the vehicle for the infant based on the acquired model.

The interface 1310 may acquire a model for predicting a driving environment of the vehicle and acquire information associated with a driving state of the vehicle or information associated with an external environment of the vehicle. The controller 1320 may determine a driving scheme using the acquired model based on the acquired information. The model may be an AI model trained based on the information associated with the driving state or external environment of the vehicle and information associated with an actual driving environment of the vehicle.

According to example embodiments, an electronic apparatus may recognize a state of the infant and determine a driving scheme of the vehicle based on the recognized state of the infant, thereby implementing an optimal driving for taking care of the infant. Also, the electronic apparatus may determine an operation scheme of at least one device in the vehicle based on the recognized state of the infant, thereby realizing an effective child care during the driving of the vehicle.

Effects are not limited to the aforementioned effects, and other effects not mentioned will be clearly understood by those skilled in the art from the description of the claims.

The devices in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer-readable recording medium may be dispersed to computer systems connected by a network so that computer-readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The above-described embodiments are merely examples and other embodiments may be implemented within the scope of the following claims.

What is claimed is:

1. An operation method of an electronic apparatus, the method comprising:
recognizing a state of an infant in a vehicle based on sensing information associated with the infant;
determining a driving scheme of the vehicle for the infant based on the recognized state of the infant; and
controlling the vehicle based on the determined driving scheme.

2. The operation method of claim 1, wherein the recognizing comprises:
acquiring a model for predicting a state of the infant;
acquiring sensing information associated with at least one of an appearance, a sound, and a gesture of the infant; and
recognizing a state of the infant based on the acquired sensing information using the model.

3. The operation method of claim 2, wherein the model is an artificial intelligence (AI) model trained based on first information associated with at least one of an appearance, a sound, and a gesture of at least one infant and second information associated with a state of the at least one infant, the second information being target information of the first information.

4. The operation method of claim 2, wherein the model is modeled based on information associated with a life pattern of the infant on an hourly basis.

5. The operation method of claim 1, wherein the determining comprises determining at least one of a predicted driving route and a driving speed of the vehicle based on the state of the infant.

6. The operation method of claim 1, wherein the determining comprises determining an operation scheme of at least one device in the vehicle based on the state of the infant, and
the controlling comprises controlling the at least one device based on the determined operation scheme.

7. The operation method of claim 6, wherein the at least one device comprises at least one of a car seat, a display device, a lighting device, an acoustic device, and a toy.

8. The operation method of claim 1, wherein the determining comprises:
acquiring a model representing a preference of the infant with respect to a driving environment of the vehicle; and
determining a driving scheme of the vehicle for the infant based on the acquired model.

9. The operation method of claim 8, wherein the model is an AI model trained based on a reaction of the infant to the driving environment of the vehicle.

10. The operation method of claim 1, wherein the determining comprises:
acquiring a model for predicting a driving environment of the vehicle;
acquiring information associated with a driving state of the vehicle or information associated with an external environment of the vehicle; and
determining a driving scheme of the vehicle based on the acquired information using the acquired model.

11. The operation method of claim 10, wherein the model is an AI model trained based on the information associated with the driving state or external environment of the vehicle and information associated with an actual driving environment of the vehicle.

12. A non-volatile computer-readable recording medium comprising a computer program for performing the operation method of claim 1.

13. An electronic apparatus comprising:
an interface configured to acquire sensing information associated with an infant in a vehicle; and
a controller configured to recognize a state of the infant based on the acquired sensing information, determine a driving scheme of the vehicle for the infant based on the recognized state of the infant, and control the vehicle based on the determined driving scheme.

14. The electronic apparatus of claim 13, wherein the interface is configured to acquire a model for predicting a state of the infant and sensing information associated with at least one of an appearance, a sound, and a gesture of the infant, and
the controller is configured to recognize a state of the infant based on the acquired sensing information using the model.

15. The electronic apparatus of claim 13, wherein the controller is configured to determine at least one of a predicted driving route and a driving speed of the vehicle based on the state of the infant.

16. The electronic apparatus of claim 13, wherein the controller is configured to determine an operation scheme of at least one device in the vehicle based on the state of the infant, and control the at least one device based on the determined operation scheme.

17. The electronic apparatus of claim 16, wherein the at least one device comprises at least one of a car seat, a display device, a lighting device, an acoustic device, and a toy.

18. The electronic apparatus of claim 13, wherein the interface is configured to acquire a model representing a preference of the infant with respect to a driving environment of the vehicle, and
the controller is configured to determine a driving scheme of the vehicle for the infant based on the acquired model.

19. The electronic apparatus of claim 13, wherein the interface is configured to acquire a model for predicting a driving environment of the vehicle, and information associated with a driving state of the vehicle or information associated with an external environment of the vehicle, and
the controller is configured to determine a driving scheme of the vehicle based on the acquired information using the acquired model.

20. The electronic apparatus of claim 19, wherein the model is an AI model trained based on the information associated with the driving state or external environment of the vehicle and information associated with an actual driving environment of the vehicle.
